(19) United States
(12) Patent Application Publication
(10) Pub. No.: US 2009/0159176 A1
(43) Pub. Date: Jun. 25, 2009

(54) SEALING METHOD FOR CONTAINING MATERIALS

(75) Inventors: Jurgen H. Daniel, San Francisco, CA (US); Peter M. Kazmaier, Mississauga (CA); Naveen Chopra, Oakville (CA)

Correspondence Address: MARGER JOHNSON & MCCOLLOM/PARC, 210 MORRISON STREET, SUITE 400, PORTLAND, OR, 97204, US

(73) Assignee: Palo Alto Research Center Incorporated, Palo Alto, CA (US)

(21) Appl. No.: 11/962,375

(22) Filed: Dec. 21, 2007

(51) Int. Cl. B65B 7/00; B32B 1/08

(52) U.S. Cl. 156/69; 428/34.1

(57) ABSTRACT

A method to seal cells includes providing a substrate having at least one cell, laminating a membrane onto the cells such that there is at least one aperture over each cell, introducing a functional material into each cell through the aperture, and sealing the apertures with a sealant that is self-supporting. A device has at least one cell having walls, a membrane forming a lid of the cell, having at least one aperture, a functional material in the cell, and a self-supporting sealant to seal the aperture.

### BACKGROUND

The ability to contain liquids, powders or gases in microfabricated cells, arranged in arrays, grids or otherwise, would have many potential applications. However, sealing the materials into the cells presents a series of challenges.

In one approach, the functional material, such as ink, powders, drugs, oils, fragrances, or other chemical or biological substances, is first filled into the cells. The functional material may be doctor bladed into the cells. The cells are then sealed with a liquid over-coating. However, the liquid used in sealing may actually pull the functional material out of the cells or intermix with the functional material. Therefore precise process control and a careful choice of materials, with regard to density and surface tensions of the liquids, is required. In addition, the liquid over-coating would not work if the functional material consisted of particles, such as powders, or gases.

In another approach, polymer sheets could be laminated over the cells. This can give rise to issues with uniformity, as the liquid gets disturbed in the lamination process. Moreover, if there is liquid in the cells, the liquid may negatively affect the adhesive used to attach the sheets to the shells. On the other hand, the adhesive of the tape may also trap particles or otherwise interfere with the substance in the cells. Another option may involve heat laminating the sheet over the cells. However, depending upon the functional material, heat may destroy the functional material, cause liquids to out-gas, etc.

### BRIEF DESCRIPTION OF THE DRAWINGS

FIGS. 1-5 show an embodiment of a method of manufacturing a cell containing functional material.

FIG. 6 shows an alternative embodiment of a cell containing functional material.

FIG. 7 shows an alternative embodiment of a method of manufacturing a cell containing functional material.

FIGS. 8-11 show alternative embodiments of a cell containing functional material.

FIGS. 12-13 show an alternative embodiment of a method of manufacturing a cell having functional material.

FIG. 14 shows an alternative embodiment of a cell containing functional material having a conductive layer and sealant.

FIGS. 15 and 16 show top and side views of an embodiment of a cell having functional material within and having a heater.

FIGS. 17-20 show alternative embodiments of cells having functional material within them and having heaters.

### DETAILED DESCRIPTION OF THE EMBODIMENTS

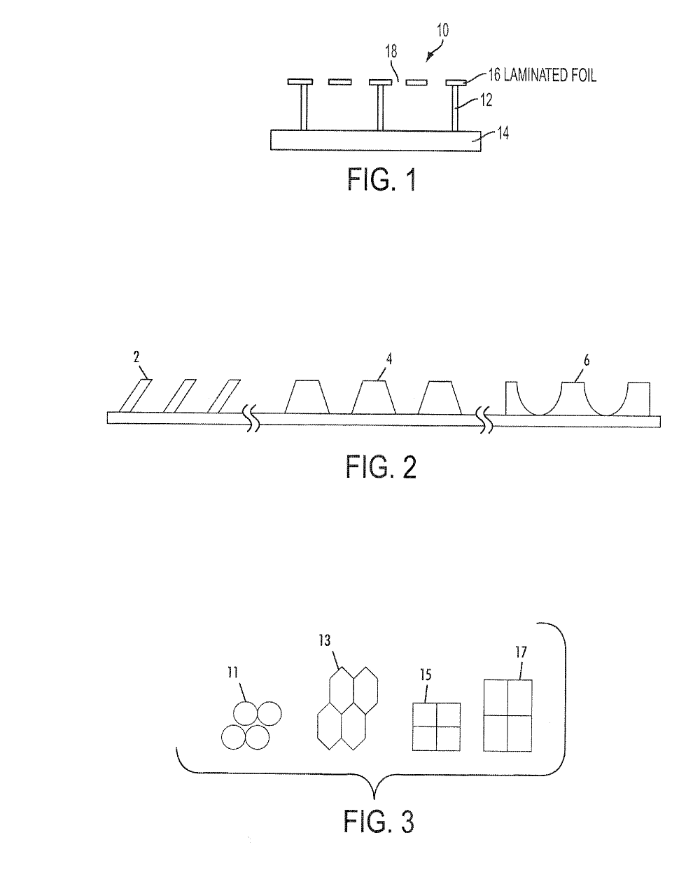

FIGS. 1-5 show an embodiment of a process to manufacture at least one cell containing with functional material. Generally, the process will apply to arrays, or grids, of cells arranged in an x-y fashion on a substrate.

FIG. 1 shows a side-view of a portion of an array of cells, such as 10. The cells may also be referred to here as ‘microcells.’ These cells will typically be of relatively small size in the range of tens of micrometers up to several millimeters in lateral and vertical dimension. However, a microcell constitutes merely one possible embodiment of a cell and no limitation is intended, nor should it be implied, by the reference to microcells.

Each cell 10 has walls 12 formed on a substrate 14. The cells could be formed in many ways, including photolithography, possibly by using SU-8 photopolymer (MicroChem, Corp.), anisotropic etching of silicon, etching of glass, molding, stamping, embossing, laser-ablation, printing, machining, etc. The bottom of the cells may be flat, rounded or tapered, such as a pyramidal shape from anisotropic etching of silicon as shown by the various configurations 2, 4 and 6 of FIG. 2. As illustrated in FIG. 2, the cell walls may be vertical, oblique, curved, etc. The cells may also have various shapes in top-view, such as square, rectangular, round, hexagonal, etc., as shown by cell shapes 11, 13, 15 and 17 of FIG. 3.

The cells may be made from various materials, such as polymers, glass, metal and silicon and they may be made from a combination of materials such as polymer walls on a glass substrate. However, the walls and the substrate may also consist of the same material which is the case, for example, if the walls are made by etching out the substrate material. In one example, SU-8 walls are patterned on a glass substrate, in another example, SU-8 walls are patterned onto a flexible Mylar™ substrate and in a third example, cell cavities are machined by laser ablation into a polyimide (Kapton) substrate using 266 nm laser light.

A membrane is then attached to the top surface of the cell walls such that a bond forms between the cell walls and the membrane. The membrane 16 may consist of a polymer film, such as pressure sensitive tape which forms a bond upon contact with another surface. An example of a pressure sensitive tape is a partially cured polymer foil that has a certain amount of tackiness in order to form a bond. The tape may then be cured by exposure to radiation such as UV light or heat. A specific example is the dual stage PSA/UV Adhesive tape IS90453 (15, 25 or 30 microns thick) from Adhesives Research, Inc. of Glen Rock, Pa. The membrane may also be a, thermoplastic material which becomes adhesive upon heating. Moreover, the cell walls may consist of a thermoplastic material that becomes adhesive upon heating. In this case the foil could consist of a material such as thin glass, Mylar™, Kapton™ foil, etc. Alternatively, the film may be adhered to the walls using adhesive, such as a roll-coated layer of adhesive over the cell walls prior to applying the membrane. Cyanoacrylate is one example of such adhesive, a cross-linkable epoxy such as SU-8 polymer or optical adhesive (e.g. adhesive NOA71—from Norland) are other examples.

The membrane 16 has at least one aperture 18 per cell. The embodiment shown in FIG. 1 has two apertures per cell. The size and placement of the aperture or apertures will depend upon the functional material to be deposited as well as the surface energies of the sealant, as will be discussed in more detail later. The use of a second aperture may have advantages for allowing escape of trapped air, ink liquid or powder functional material examples.

Forming the aperture may occur after attaching the membrane to the cells, such as by using microneedles to puncture the membrane or by laser micromachining. However, depending upon the cost, advantages may exist in forming the apertures prior to attachment to the cells. Apertures could be stamped, etched, including laser etching, or generated during fabrication of the film, such as by molding. The apertures may also be formed by light exposure and thermal decomposition of the exposed areas if for example a light sensitive heat decomposable polymer is used such as the ‘Unity’ polymers from Promerus, LLC of Brecksville, Ohio.

The membrane does not necessarily have to be a polymer. It could also consist of a thin layer of glass or silicon or of a thin metal foil or a ceramic membrane, for example. The layer/membrane could be bonded to the walls by anodic bonding or eutectic bonding, by ultrasonic bonding, laser bonding or induction bonding. The apertures could be reactive ion etched or wet etched, ion milled or laser ablated.

The membrane forms a ‘tent’ structure that will prevent the sealing material from mixing with the content of the cells. The surface energy of the tent structure may be adjusted so that the sealing solution will be ‘pinned’ at the holes, preventing further creep into the holes.

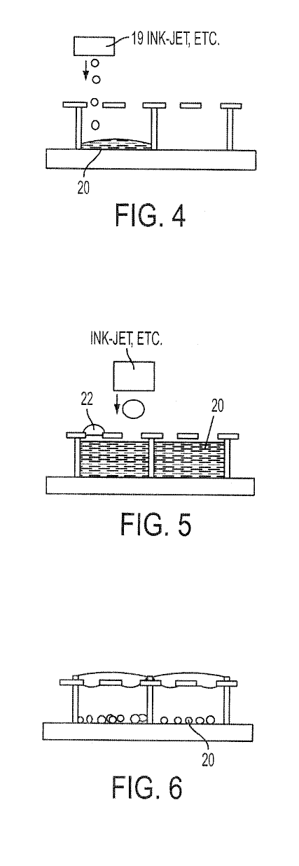

FIG. 4 shows the introduction of a functional material into the cells. This could be accomplished by ink-jet printing through the aperture using an ink-jet head 19. Generally, the size of the aperture would have to be larger than the size of the fluid drops, if a fluid is being used. Using ink-jet printing, several drops may be needed to fill the cell. If two apertures are used, the second aperture that allows trapped air to escape could typically be smaller than the drop size of the liquid. Using inkjet printing, different functional materials may be introduced into neighboring cells, such as different color display fluids or different fragrance solutions, etc.

As an example, assume a cell has an internal volume of 200×200×50 micrometers (μm), or 2 nanoliters. If the drop diameter were 40 μm, having a volume of 30 picoliters, approximately 60 drops per cell would be required to almost fill the cell. Using an ink jet print head having an ejection frequency of 20 kHz, it would take 3 milliseconds to fill one cell. For an exemplary cell array area of 10 inches by 10 inches, it would take 80 minutes to fill the 1270×1270 cells. However, using 100 nozzles, it would only take 48 seconds, and print heads with up to 1000 nozzles are available. In this example, the functional material could be for a display device and consist of a fluid such as electrophoretic ink.

If the functional material consists of gas, or a fragrance, the sealing membrane could be a porous material, such as Gore-Tex™ or even paper. A vacuum-filling method could also fill the cells with the functional material, especially where the cells were only being filled with a single substance. Alternative methods of filling, such as electrostatic filling or filling with an air stream may also fill the cells. In electrostatic filling, a charged or polarizable fluid or particles are pulled into the cells by an electric field. The field may be generated by a voltage between the cell substrate and an outside counter-electrode. Air stream filling may have advantages when the functional material is a particle, such as toner particles. Here, a stream of air or gas carries the particles through the apertures into the cells. Particles, such as micron-size particles or nanometer size particles may be filled into the cells by jet printing a dispersion of the particles and then let the solvent evaporate. Examples of particles are polystyrene particles, toner particles fabricated by an emulsion aggregation process, quantum dots, titanium dioxide particles or magnetic particles such as iron oxide particles.

The functional material is any substance that has a use for which placing it in the cells is helpful. Examples include toner particles, colored ink or powders, chemicals, drugs, oils, fragrances, gases, biological materials, etc.

Once the cell is filled or partially filled, the apertures must be sealed. FIG. 5 shows an example of a cell having had its apertures sealed. An ink-jet process may deposit the sealant 22 onto and partially into the apertures 18, as shown. Alternative processes may include drop dispensing, spray coating, dip coating or doctor blading.

As mentioned above, the sealant would not mix with the contents of the cells, due to the tent structure formed from the membrane and the cell walls and due to the properties of the sealant. The sealant fluid must have certain properties that prevent it from rapidly flowing into the cells. If the material is becoming solidified quickly enough, it will stay on top of the membrane. Solidification may occur by cooling such as in a phase-change material such as wax, or solidification may occur by cross-linking such as in the case of radiation cross-linkable polymers such as UV curable materials. Moreover, the sealing fluid may have a high enough surface tension so that it will not enter the cell apertures.

Together with a low surface energy of the membrane area around the apertures, the sealing fluid will be pinned at the apertures and does not enter the cells. The sealant or sealant fluid is referred to as ‘self-supporting’ during the sealing process because it does not rely upon the functional material in the cells to support it at the opening. This is contrasted with US Patent Publication 2002/0008898 to Katase, in which the sealant relies upon the liquid in the cells to remain in the aperture, rather than entering the cells. The sealant in Katase ‘floats’ upon the liquid in the cells until it solidifies. The sealant used in the embodiments disclosed here is self-supporting and remains in or above the aperture without relying upon the functional material.

The sealing fluid may then solidify by e.g. a cross-linking mechanism. This allows sealing of cells partially filled with a fluid or cells filled or partially filled with a powder, such as that shown in FIG. 6. Moreover, cells filled with a gas or vapor also can be sealed by this method. The sealant stops at the membrane apertures, allowing the cell to be only partially filled with functional material 20, in this example a powder or particles.

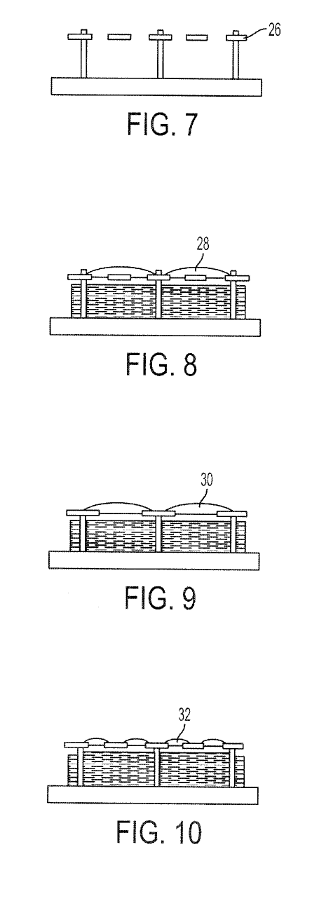

Additional walls that extend beyond the surface of the membrane may provide an additional control structure for the sealant to prevent it from spreading after deposition or to obtain a better uniformity if a method such as dip-coating is used to deposit the sealing fluid. The control structure may act as an additional barrier or pinning structure for the sealing fluid. The structure of FIG. 1 would be altered to include the barrier walls 26, shown in FIG. 7. The barrier walls would extend above the membrane, typically being formed on the membrane itself. For example these barrier walls could be deposited by jet-printing of a material such as a wax, for example Kemamide wax or a UV curable polymer such as Anapurna UV curable inks from Agfa. Alternatively, the membrane could somehow be attached and etched to allow gaps in the membrane in the middle of the cell walls and then the barrier walls would be formed. However, this latter process would involve much higher complexity.

The use of the barrier walls may allow alternative uses for the cells. For example, as shown in FIG. 8, larger amounts of sealant may be used to form domed structures such as 28. Depending upon the optical properties of the material used, these domed structures may function as lenses for light reflected from or transmitted through the cells. The barrier walls locally pin the sealing fluid within each cell area.

As mentioned above, there may be only one aperture formed in the membrane. For optical uses, this may have lower interference with the light passing through the lens material. A cell having only a single aperture 30 is shown in FIG. 9.

Similarly, FIG. 10 shows individual sealing of the apertures, such as by drop 32. This contrasts with the sealant 28 of FIG. 8, where one drop or portion of the sealant acts to seal both apertures.

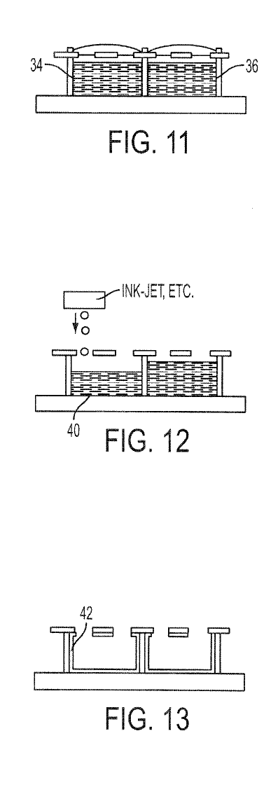

As yet another alternative, the functional material may vary from cell to cell. FIG. 11 shows a first cell having within it a first functional material 34. An adjacent cell has a second functional material 36. For example, the first functional material 34 may be a liquid or ink of one color and the adjacent cell may have a different color. Generally, this may work for display applications. The sealing material may of course also vary from cell to cell. For example, it may have a different color and therefore the sealing material may act as well as a color filter in an application where the functional material is a display material such as an electrophoretic ink or electrophoretic powder.

Many variations and modifications exist. For example, the interior, meaning at least one inside surface, of the cells may be treated with a coating before introducing the functional material. FIGS. 12 and 13 show a modification of the process shown in FIGS. 1-5. Starting with the structure of FIG. 1, the process would include a process such as shown in FIG. 12, where a coating material 40 fills the cells. The coating material may consist partially of an evaporable solvent. After the solvent evaporates, a thin surface coating 42 inside the cells remains behind, as seen in FIG. 13. Examples of such a coating may be a fluorocarbon, such as Cytop™, polycarbonate, polystyrene, PMMA, polyvinylalcohol, organosilane coatings to give the surface a certain functionality or biocompatible coatings such as bovine serum albumin (BSA), polydimethylsiloxane, gelatin, etc. These coatings affect the functional material.

In an alternative embodiment, limiting the amount of coating material dispensed, only the bottom, or only the bottom and parts of the walls may end up with the coating. Also, using jet printing, the coating could vary from cell to cell, much like the functional material was varied in FIG. 11. Different coatings may be required for different functional fluids in neighboring cells. The surface coating inside the cells affects the interaction of the introduced functional material with the cell walls. For example, some low-surface-energy coatings may reduce the adsorption of particles on the cell wall surface. A biologically compatible surface coating inside the cells may prevent the adsorption of biological substances, For example, a polyethylene glycol silane coating may prevent the adsorption of proteins.

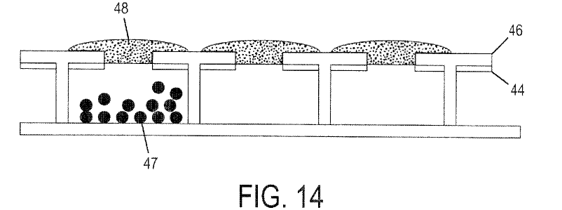

FIG. 14 shows a more complex structure using conductive structures. Either prior to attachment, or by a two-step attachment process, a conductive layer 44 would reside on the cell-side of the membrane 46, above the functional material 47. For example, the attached membrane 46 may be pre-coated with a layer of indium tin oxide (ITO) or other conductive material prior to attachment. The conductive coating may be patterned into pixels (picture elements) for selective, electrical activation on a cell-by-cell basis.

The sealant 48 could also be made conductive by the addition of conductive particles or structures, such as metal nanoparticles or carbon nanotubes (CNT). Alternatively, an organic conductor may be used as a sealant. This structure of FIG. 14 has a conductive plug 48, allowing the cell to be electrically contacted from its top surface.

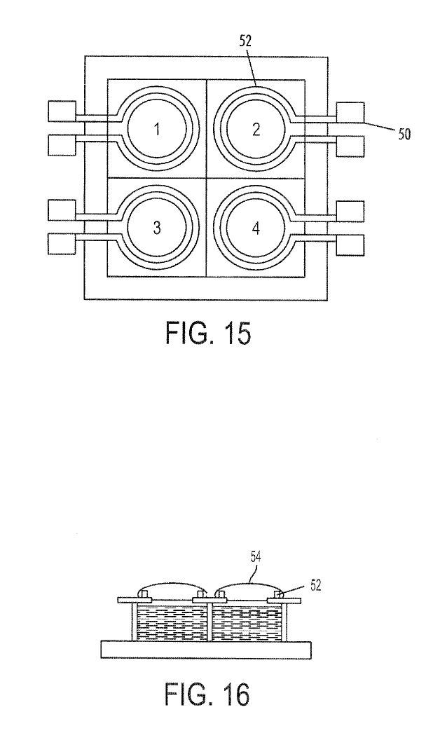

In yet another alternative, the sealant may be a thermally or otherwise decomposable material. For example, if a heat decomposable polymer were used, heating elements or heaters could be manufactured on the membrane. They could be either deposited by printing of silver lines or they could be patterned by conventional lithography and etching methods or by laser-ablation. FIG. 15 shows an example of a heater structure deposited on the membrane. The heaters such as 52 would have contact or connection pads 50 that would allow heating of the element 52 by passing an electrical current through the conductive path.

The application of heat would cause the sealant 54 shown in FIG. 16 to decompose. Heat decomposable materials are known such as the polycarbonate-based materials from Promerus, LLC, under the trade name of ‘Unity’. Upon decomposition, the cell seal would break, allowing escape of the contents of the cells, such as gas, fragrance, etc. One example would be a fragrance array, where each cell contained a different fragrance or chemical. The structure or device could be used to dispense discrete amounts of a fluid in a timed manner. This would have applications for lubrication, where an amount of lubrication oil is released from the cells in a controlled way. Moreover, if the cells contain a fragrance or a perfume, the release of the substance could be timed accurately. The sealing polymer 54 may also consist of a polymer that melts above a certain temperature range such as a wax or other themmoplastic polymer.

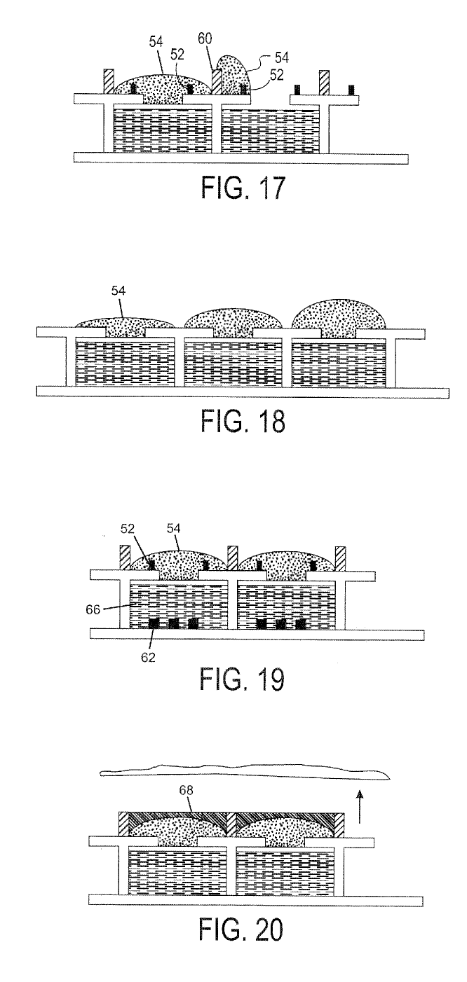

In this case, the heat from the heaters 52 will melt, thermally decompose or otherwise operate on the material, upon which the polymer may wick into or onto a neighboring structure. Such a structure could be a sidewall with a high surface energy coating or it may be a sponge-like structure which contains capillaries that attract the sealing material due to capillary forces, as shown as 60 in FIG. 17.

As mentioned earlier, the sealing polymer may be different from cell to cell. Here, for example the melting points or decomposition temperatures may be different from cell to cell. However, also the amount of deposited sealing material may vary from cell to cell as shown in FIG. 18. If the sealing material is for example a material that dissolves in a humid/moist environment or in a liquid, then different amounts of sealing material require different times for dissolution. Therefore, a timed release of the functional material from within the cells can be programmed by adjusting the amount of sealing material. In a device that releases a functional material from the cells such as release of drugs, oils, odors, etc., an actuation mechanism may also be included within the cells, for example on the bottom of the cells.

As shown FIG. 19, this may be in form of a heating element, a piezoelectric actuator or other actuator 62 that forces or otherwise operates on the functional material 66 out of the cells once the sealing material has been removed. For example, a heating element may heat a fragrance fluid and cause evaporation and a piezo actuator may, for example, atomize a liquid. With such actuation mechanisms, the heater 52 may not be necessary if the force generated within a cell is high enough to pop off the sealing layer.

As a specific example for an application, FIG. 20 shows a drug delivery system attached to the skin of a patient as in a skin patch. Here, the cell openings are facing the skin and the functional fluid within the cells gets in contact with the skin upon release. The skin may then absorb the functional fluid, such as nitroglycerine for treating heart problems. The release may be triggered electronically, for example, in one of the ways described above. In the figure, a spongy material 68 is shown between the skin and the cell opening. This material, such as a cellulose sponge may absorb the functional fluid and assist in extracting it out of the cells. From there it may be absorbed by the skin. This sponge material may be optional.

Alternatively, the cells could be coated as mentioned above with regard to FIGS. 12 and 13 with a reactive coating and the cells could act as a sensor as the external environment would contact the coating upon removal of the seal 52 of FIG. 16. In some example coatings, the coatings change color or otherwise react when in the presence of certain materials, such as contaminants, etc. The cells may also contain various chemical or biological reagents which may react with an external fluid or substance upon release. For example, they could contain various acidity indicator solutions or various fluorescent labels. Once the substance is released from the cells, it may react with the environment and cause a color change or fluorescence. This may be used to determine the composition of an external substance or the presence of a dangerous substance such as an acid or a biothreat agent. For example, releasing the substance from the cells, as occurs with military chemical sensors, may cause a clear substance to turn yellow in the presence of certain gases or elements of gases. This alerts the personnel in the area of the presence of a dangerous gas or element in the air.

In this manner an array of microcells could be fabricated and filled with a functional material with a wide-variety of purposes in a relatively fast and efficient manner.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method to seal cells, comprising:
providing a substrate having at least one cell;
laminating a membrane onto the cells such that there is at least one aperture over each cell;
introducing a functional material into each cell through the aperture; and
sealing the apertures with a sealant that is self-supporting.

2. The method of claim 1, wherein providing a substrate further comprises patterning microcells one of either into or onto a substrate.

3. The method of claim 2, wherein patterning further comprises one of photolithographic patterning, etching, molding, stamping, embossing, laser ablation, and machining.

4. The method of claim 1, wherein laminating a membrane further comprises one of heat laminating, radiation curing, heat curing, pressing, or adhering.

5. The method of claim 1, wherein laminating a membrane such that there is at least one aperture further comprises one of laminating a membrane having apertures, or laminating a membrane without apertures and then forming the apertures after lamination.

6. The method of claim 5, wherein forming the apertures further comprises laser micromachining, puncturing the membrane with microneedles, stamping, thermal decomposition, etching, or molding.

7. The method of claim 1, wherein introducing the functional material further comprises one of ink-jet printing, vacuum-filling, electrostatic filling, or filling with an air stream.

8. The method of claim 1, wherein sealing the apertures further comprises jet printing, drop dispensing, dip-coating, spray coating or doctor blading.

9. The method of claim 1, further comprising introducing a material from solution that leaves a surface coating on an inner surface of the cell, the surface coating to affect the interaction of the functional material with the cell walls

10. A device, comprising:
at least one cell having walls;
a membrane forming a lid of the cell, having at least one aperture;
a functional material in the cell; and
a self-supporting sealant to seal the aperture.

11. The device of claim 10, wherein the membrane further comprises one of a polymer film, a radiation curable film, a heat curable film, a pressure sensitive tape, glass, silicon, or a Mylar sheet.

12. The device of claim 10, wherein the functional material further comprises one of ink, liquid, powder, gas, drugs, oils, chemicals, or biological material.

13. The device of claim 10, the device further comprising at least one wall on a top surface of the membrane, corresponding to the walls of the cell, positioned to laterally confine the sealant.

14. The device of claim 13, wherein the sealant further comprises a dome-shaped layer of at least partially transparent material to act as a lens.

15. The device of claim 10, wherein the sealant further comprises one of a dye or pigment to act as a color filter.

16. The device of claim 10, wherein the sealant further comprises an electrically conductive sealant.

17. The device of claim 10, further comprising at least one heater.

18. The device of claim 17, wherein the heater is arranged to one of either melt or thermally decompose the sealant to allow release of the functional material.

19. The device of claim 10, further comprising at least one actuator to operate on the functional material.

20. The device of claim 10, wherein the sealant further comprises one of either a heat decomposable material or a thermoplastic material.

21. The device of claim 10, the device further comprising at least a partial coating of at least one inside surface of the cell.
